(19) United States
(12) Patent Application Publication
(10) Pub. No.: US 2012/0158262 A1
(43) Pub. Date: Jun. 21, 2012

(54) VEHICLE SHIFT CONTROL APPARATUS

(75) Inventors: Masayuki NISHIDA, Tokyo (JP); Hiroki Tanaka, Tokyo (JP); Takahito Morishita, Tokyo (JP); Keisuke Ajimoto, Tokyo (JP); Shinya Yasunaga, Tokyo (JP)

(73) Assignee: Fuji Jukogyo Kabushiki Kaisha, Tokyo (JP)

(21) Appl. No.: 13/307,265

(22) Filed: Nov. 30, 2011

(30) Foreign Application Priority Data
Dec. 15, 2010 (JP) 2010-279582

(51) Int. Cl. F16H 61/00

(52) U.S. Cl. 701/55; 701/51

(57) ABSTRACT

A vehicle shift control apparatus has a plurality of driving force modes in which an engine generates driving force in response to an accelerator operation, a shift control unit for controlling a transmission gear stage or a transmission ratio of an automatic transmission according to a preset shift characteristic, The apparatus sets a different shift characteristic for each of the modes upon shifting from a current transmission gear stage or transmission ratio to a target transmission gear stage or transmission ratio by means of the shift control unit, and performs a gear shift according to a currently selected shift characteristic.

### CROSS-REFERENCES TO RELATED APPLICATIONS

The present application claims priority from Japanese Patent Application No. 2010-279582 filed on Dec. 15, 2010, the entire contents of which are hereby incorporated by reference.

### BACKGROUND OF THE INVENTION

1. Field of the Invention

The present invention relates to a vehicle shift control apparatus that is operable in a vehicle that has a plurality of driving force modes for a in which an engine generates driving force in response to an accelerator operation and an automatic transmission configured to be controlled in an automatic shift mode and in a manual shift mode.

2. Description of the Related Art

There have been proposed and practically used various types of vehicles having shift modes including an automatic shift mode for automatically controlling a transmission gear ratio according to a preset shift characteristic as well as a manual shift mode for manually selecting one of a plurality of preset transmission gear stages so as to shift a transmission gear stage into a specifically fixed transmission gear ratio example, see Japanese Unexamined Patent Application Publication No. 2005-42871).

There has also been developed and practically used a vehicle having a plurality of modes for a driving force characteristic to be produced by an engine in response to an accelerator operation. These driving force modes include a comfort-oriented and economy-oriented driving force mode and a sport-oriented and maneuverability-oriented driving force mode. When one of the modes is selected in order to satisfy driver's requirements, the engine is operated according to a driving force characteristic corresponding to the selected mode. If a technology including shift control such as disclosed in the Japanese Unexamined Patent Application Publication No. 2005-42871 is applied to such a vehicle having a plurality of driving force modes, shift characteristics are required that allow the vehicle to be driven under a driving condition desired by a driver

### SUMMARY OF THE INVENTION

The present invention has been made in view of the above circumstances. It is an object of the present invention to provide a vehicle shift control apparatus that changes a shift characteristic according to a driving force characteristic selected by a driver and thereby makes a distinct difference among the driving force modes selected by the driver in order to enhance driver's convenience.

One aspect of the present invention provides a vehicle shift control apparatus that is operable in a vehicle having a plurality of driving force modes in which an engine generates driving force in response to an accelerator operation and a shift control unit for controlling a transmission gear stage of an automatic transmission connected to the engine according to a preset shift characteristic. The vehicle shift control apparatus has a shift characteristic storage unit in which a shift characteristic for shifting from a current transmission gear stage to a target transmission gear stage by means of the transmission control unit is stored for each of the modes, a shift characteristic selection unit for selecting a shift characteristic which corresponds to a currently selected mode, and a control unit for performing a gear shift according to the selected shift characteristic so as to change a transmission gear stage.

### BRIEF DESCRIPTION OF THE DRAWINGS

FIG. 1 is a schematic block diagram of a power train that is mounted on a vehicle according to an embodiment of the present invention;

FIG. 2 is a flowchart illustrating engine throttle control according to the embodiment of the present invention.

FIG. 3 is a flowchart illustrating shift control of a continuously variable transmission according to the embodiment of the present invention.

FIGS. 4A to 4C are conceptual diagrams respectively illustrating a normal mode map, a save mode map and a power mode map of an engine according to the embodiment of the present invention.

FIG. 5 is a conceptual diagram illustrating an automatic shift map according to the embodiment of the present invention.

FIG. 6 is a conceptual diagram illustrating a manual shift map according to the embodiment of the present invention.

FIGS. 7A to 7C are explanatory diagrams illustrating characteristics of shift filters selected according to the respective modes.

FIGS. 8A to 8C are explanatory diagrams illustrating characteristics of shift filters selected according to the respective modes except that are different from the ones shown in FIGS. 7A-7C.

FIGS. 9A to 90 illustrate characteristics of shift filters selected in accordance with the respective modes that are different from the ones shown in FIGS. 7A to 8C.

### DESCRIPTION OF THE PREFERRED EMBODIMENTS

An embodiment of the present invention will be explained with reference to the drawings.

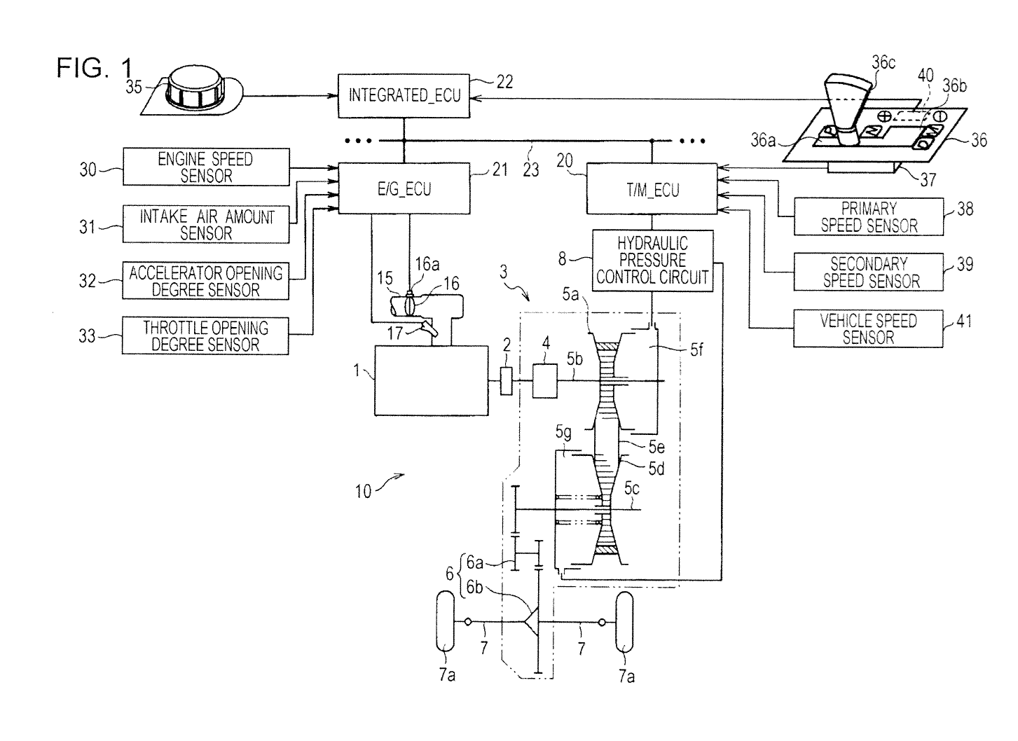

In FIG. 1, reference numeral 1 indicates an engine. The engine 1 forms a main part of a power train 10 by being connected to a continuously variable transmission 3, which is an example of an automatic transmission, via a starting clutch 2 such as an electromagnetic clutch or a torque converter.

The continuously variable transmission 3 has a forward-reverse changeover device 4 connected to the starting clutch 2. A primary pulley 5a is pivotally supported by a pulley input shaft 5b extending from the forward-reverse changeover device 4. Further, a secondary pulley 5d is pivotally supported by a pulley output shaft 5c that is arranged in parallel with the pulley input shaft 5b. A driving belt 5e is mounted in such a manner as to be wrapped around the primary pulley 5a and the secondary pulley 5d. Furthermore, the pulley output shaft 5c is connected to a differential device 6b via a reduction gear group 6a of a final reduction gear 6. The differential device 6b is connected to a driving shaft 7 to which a front or rear drive wheel 7a is pivotally attached.

A primary hydraulic pressure chamber 5f is provided adjacent to the primary pulley 5a. A groove width of the primary pulley 5a is adjusted by means of primary hydraulic pressure supplied to the primary hydraulic pressure chamber 5f from a hydraulic pressure control circuit 8. Meanwhile, a secondary hydraulic pressure chamber 5g is provided adjacent to the secondary pulley 5d. A tensile force required for torque transmission is provided to the drive belt 5e through a secondary hydraulic pressure supplied to the secondary hydraulic pressure chamber 5g from the hydraulic pressure control circuit 8.

The hydraulic pressure control circuit 8 is controlled by a transmission control unit (T/M_ECU) 20 to be described later. The groove widths of the pulleys 5a and 5d are controlled through hydraulic pressure control so as to be inversely proportional to each other, thereby allowing the continuously variable transmission 3 to attain a desired transmission gear ratio.

The T/M_ECU 20 is connected to various control units such as an engine control unit (E/G_ECU) 21 and an integrated control unit (integrated_ECU) 22 through an in-vehicle communication line 23 such as a line using CAN (Controller Area Network) communication so as to allow communication therewith. Each of the ECUs 20 to 22 mainly includes a microcomputer that contains a CPU, a ROM, a RAM, a non-volatile storage unit such as an EEPROM that are well-known.

To an input side of the T/M_ECU 20 connected are, for example, a primary speed sensor 38 for detecting a speed (primary speed Np) of the primary pulley 5a, a secondary speed sensor 39 for detecting a speed (secondary speed Ns) of the secondary pulley 5d, a vehicle speed sensor 41 for detecting a vehicle speed V, an inhibitor switch 37 for detecting a range selected on a selector 36. Further, actuators such as the hydraulic pressure control circuit 8. are connected to an output side of the T/M_ECU 20.

The selector 36 of the present embodiment has, for example, a main gate 36a in which a parking (P) range, a reverse (R) range, a neutral (N) range and a drive (D) range are set, and a sub-gate 36b in which a manual (M) range is set. Each of the ranges on the respective gates 36a and 36b can be selected by way of a select lever 36c. The inhibitor switch 37 detects a selected range. In the sub-gate 36b, upshift (+) and downshift (−) positions are set with the manual range disposed therebetween. A manual switch 40 to be described later is disposed adjacent to the upshift and downshift positions. Then, when the select lever 36c is moved to the upshift or downshift position while the manual range is selected, the manual switch 40 outputs an upshift signal or a downshift signal. The manual switch 40 may include, for example, a paddle switch disposed in a steering wheel.

To an input side of the E/G_ECU 21 connected are various sensors such as an engine speed sensor 30 for detecting an engine speed Ne based on the rotations of a crankshaft, an intake air amount sensor 31 that is disposed, for example, immediately downstream of an air cleaner and detects an intake air amount Q, an accelerator opening degree sensor 32 for detecting an actual accelerator opening degree θacc based on the amount of the depression of an accelerator pedal, a throttle opening degree sensor 33 for detecting an opening degree θth of an electronically-controlled throttle valve 16 provided in an intake air passage 15. To an output side of the E/G_ECU 21 connected are, for example, an injector 17 that injects a predetermined amount of fuel and an actuator that controls engine operation such as a throttle actuator 16a provided in the throttle valve 16.

To an input side of the integrated_ECU 22 connected are, for example, the above-described manual switch 40 described above and a mode selection switch 35 for selectively switching between control modes of the driving force characteristics generated by the power train 10 in response to an accelerator operation.

In the present embodiment, the driving force modes of the power train 10 include three kinds of mode M: a normal mode M1, a save mode M2 and a power mode M3. The integrated_ECU 22 outputs mode information selected by a driver via the mode selection switch 45 to the T/M_ECU 20 and the E/G ECU 21 through the in-vehicle communication line 23. The mode selection switch 35 of the embodiment uses a shuttle switch that has a push switch therein and automatically returns to the middle point. When the driver turns the switch counterclockwise, the normal mode M1 is identified. When the driver presses the switch, the save mode M2 is identified. When the driver turns the switch clockwise, the power mode M3 is identified.

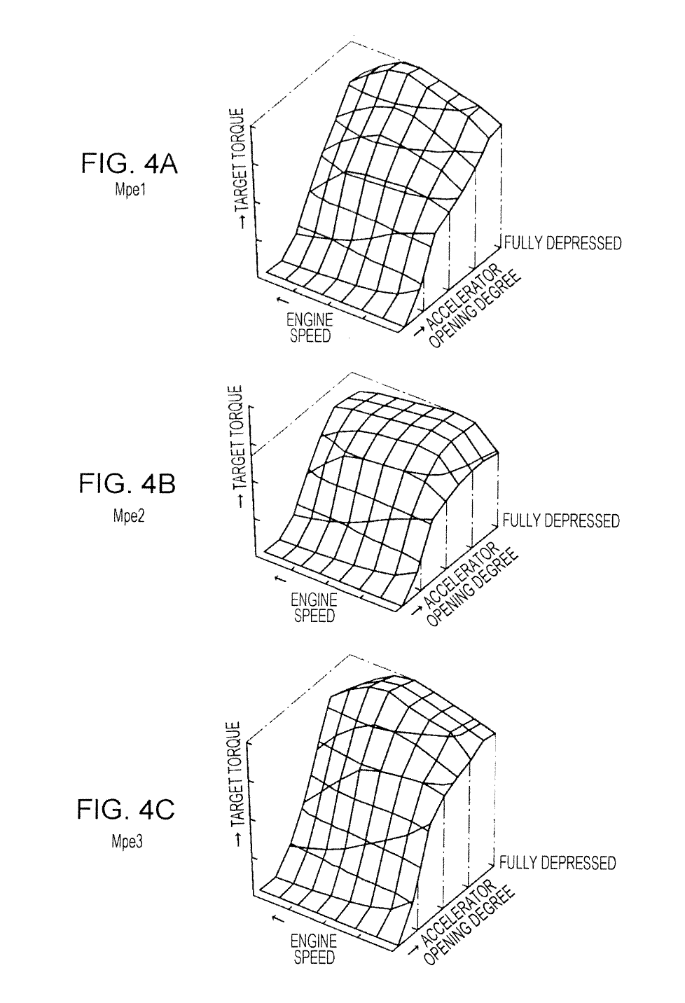

The E/G_ECU 21 has, for example, three mode maps Mpe1, Mpe2 and Mpe3 preset and stored in a memory thereof that represent engine output characteristics. As shown in FIGS. 4A to 4C, each of the mode maps includes a three-dimensional map in which lattice axes represent the accelerator opening degree θacc and the engine speed Ne, and each of lattice points stores an engine output instruction value (target torque).

The mode maps Mpe1, Mpe2 and Mpe3 are basically selected by the driver via the mode selection switch 35. That is, the E/G_ECU 21 selects the normal mode map Mpe1 when the normal mode M1 is selected via the mode selection switch 35, the save mode map Mpe2 when the save mode M2 is selected, and the power mode map Mpe3 when the power mode M3 is selected.

Based on the selected mode map Mpe and detection signals from various sensors, the E/G_ECU 21 sets a fuel injection timing and a fuel injection pulse width (pulse time) for the injector 17. Further, the E/G_ECU 21 outputs a throttle opening signal to the throttle actuator 16a, thereby controlling the opening degree of the throttle valve 16.

The normal mode map Mpe1 shown in FIG. 4A is configured to have target torque that linearly changes when the accelerator opening degree θacc is relatively small and reaches its maximum when the throttle valve 16 is almost fully open.

The save mode map Mpe2 shown in FIG. 4B is configured to place a particular emphasis on driving comfort and economy, in which a rise in target torque is suppressed as compared to the normal mode map Mpe1, and the throttle valve 16 does not fully open even if the accelerator pedal is fully depressed. A change in the opening degree of the throttle valve 16 is relatively smaller than that in the normal mode when the accelerator pedal is depressed. Thus, even if the accelerator pedal is depressed by a same amount as in the normal mode, the throttle opening degree θe remains small, which suppresses a rise in output torque. As a result, accelerator operations such as fully depressing the accelerator pedal can be enjoyed by causing the vehicle to be driven with the output torque suppressed according to the save mode map Mpe2. In addition, since a rise in target torque is suppressed, a good balance can be achieved between ease of driving and better fuel economy. For example, even a vehicle equipped with a three-liter engine provides smooth and mild output characteristics while producing a sufficient output comparable to a two-liter engine, in which the target torque is set in such a manner that importance is placed on ease of handling in a practical operating range, particularly, during city driving.

The power mode map Mpe3 shown in FIG. 4C places a particular emphasis on sport driving or maneuverability, and is configured to provide a greater rate of change in target torque in response to a change in the accelerator opening θacc over substantially the entire operating range. Thus, in the case of a vehicle equipped with a 3-liter engine, the target torque is set so as to allow the 3-liter engine to provide its maximum potential.

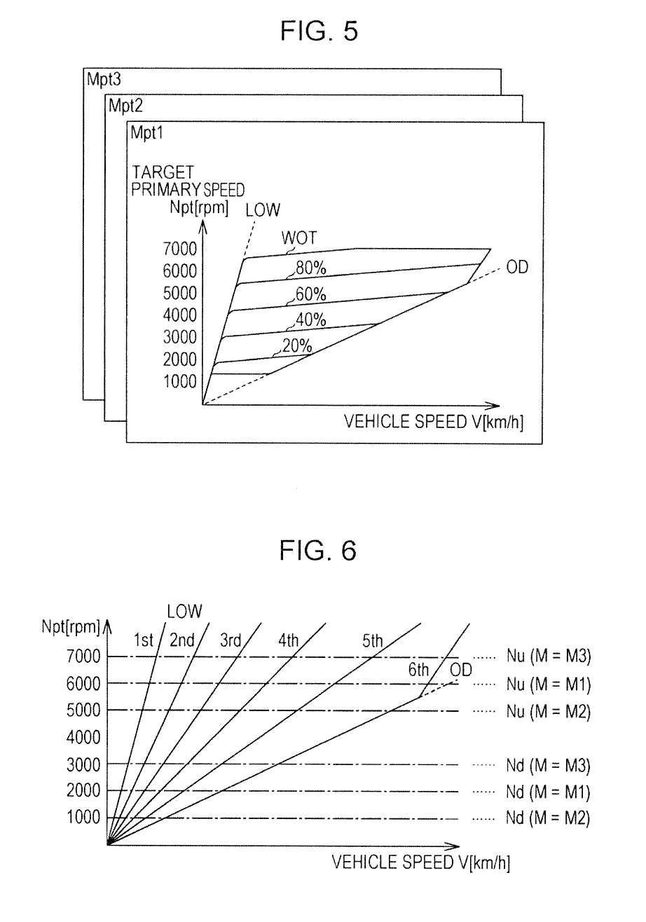

The T/M_ECU 20 has, for example, automatic shift maps Mpt1 to Mpt3 (see FIG. 5) for automatically controlling the transmission gear ratio of the continuously variable transmission 3 according to the shift characteristics corresponding to the mode maps Mpe1 to Mpe3 described above and a manual shift map Mptm (see FIG. 6) for controlling the transmission gear ratio of the continuously variable transmission 3 to a fixed transmission gear ratio of a predetermined gear stage (for example, first to sixth gear stages), preset and stored in a memory thereof. Based on the selected shift map Mpt and detection signals from various sensors, the T/M_ECU 20 controls the transmission gear ratio of the continuously variable transmission 3 by controlling the hydraulic pressures to be supplied to the hydraulic pressure chamber 5f and the hydraulic pressure chamber 5g by the hydraulic pressure control circuit 8.

Among these maps, the automatic shift maps Mpt1 to Mpt3 are selectively used depending on the mode M selected via the mode selection switch 35, when the drive range is selected on the selector 36, and the continuously variable transmission 3 is set to the automatic shift control mode. That is, the T/M_ECU 20 selects the automatic shift map Mpt1 when the normal mode M1 is selected through the mode selection switch 45, the automatic shift map Mpt2 when the save mode M2 is selected, and the automatic shift map Mpt3 when the power mode M3 is selected, so as to comply with the mode maps Mpe of the engine 1, respectively. Then, by referring to the thus selected automatic shift map Mpt, the T/M_ECU 20 sets a target primary speed Npt on the basis of the current vehicle speed V and the accelerator opening degree θacc, and thereby controls the transmission gear ratio such that the primary speed Np matches the primary speed Npt.

As shown in FIG. 5, for example, each of the automatic shift maps Mpt1 to Mpt3 includes a map in which a shift characteristic line indicating a relationship between the vehicle speed V and the target primary speed Npt is set for each value of the accelerator opening degree θacc between a maximum transmission gear ratio LOW and a minimum transmission gear ratio overdrive (OD). In this case, in order to comply with the mode maps Mpe1 to Mpe3 for the engine output characteristics described above, the shift characteristic lines on the automatic shift maps Mpt1 to Mpt3 are basically set so as to calculate a value of the target primary speed Npt at which the shift characteristic line for the mode M2 is relatively lower than the shift characteristic line for the mode M1 and to calculate a value of the target primary speed Npt at which the shift characteristic line for the mode M3 is relatively higher than the shift characteristic line for the mode M2 under the same vehicle speed V and accelerator opening θacc.

With this setting, a proper shift control is performed based on the output characteristic of the engine 1 in the automatic shift mode where the drive range is selected on the selector 36, thereby allowing the power train 10 to produce a characteristic driving force for each of the modes selected by the mode selection switch 35.

Meanwhile, when the range of the selector 36 is changed from the drive range to the manual range so that the control mode of the continuously variable transmission 3 is changed from the automatic shift mode to the manual shift mode, the T/M_ECU 20 selects the manual shift map Mptm (see FIG. 6) for shift control.

Further, the T/M_ECU 20 has a filter characteristic to be described later that sets a different shift characteristic for shifting a current transmission gear ratio to a target transmission gear ratio in the manual shift mode for each of the driving force modes (M1, M2 and M3) described above. When the manual shift map Mptm described above is selected, a filter characteristic having a shift characteristic corresponding to the currently selected mode (M1, M2 or M3) is selected.

The T/M_ECU 20 basically shifts up the transmission gear ratio of the continuously variable transmission 3 sequentially from the current transmission gear ratio to a fixed transmission gear ratio of a higher gear stage under the filter characteristic for the selected shift characteristic every time an upshift signal is output from the manual switch 40 via the integrated_ECU 22. Otherwise, the T/M_ECU 20 shifts down the transmission gear ratio of the continuously variable transmission 3 sequentially from the current transmission gear ratio to a fixed transmission gear ratio of a lower gear stage under the filter characteristic for the selected transmission characteristic every time a downshift signal is output from the manual switch 40 via the integrated_ECU 22.

For some purposes such as preventing overspeed of the engine 1, the T/M_ECU 20 automatically changes the transmission gear ratio to a fixed transmission gear ratio of a higher gear stage if the primary speed Np, which is an input speed to the continuously variable transmission 3, exceeds a preset automatic upshift speed Nu. Further, for some purposes such as securing required acceleration performance and thereby enhancing drivability, the T/M_ECU 20 automatically changes the transmission gear ratio to a fixed transmission gear ratio of a lower gear stage when the primary speed Np falls below a preset automatic downshift speed Nd.

Each of The automatic upshift speed Nu and the automatic downshift speed Nd has a different value for each driving force mode M.

Specifically, the automatic upshift speed Nu is, for example, set higher for a mode of a driving power characteristic that has higher responsiveness to an accelerator operation. Thus, the automatic upshift speed Nu is set highest in the power mode M3, lower in the normal mode M1 and further lower in the save mode M2. Assuming that, for example, that the maximum speed of the engine 1 is set to 7000 [rpm] for preventing excessive rotation thereof, and that the engine speed Ne upon a forward move in which the starting clutch 2 is fastened and the primary speed Np uniquely correspond to each other, the automatic upshift speed Nu is set to 7000 [rpm] for the power mode M3 (M=M3), 6000 [rpm] for the normal mode M1 (M=M1) and 5000 [rpm] for the save mode M2 (M=M2).

Further, the downshift speed Nd of the present embodiment is, for example, set higher for a mode of a driving power characteristic having higher responsiveness to an accelerator operation. Thus, the downshift speed Nd becomes highest in the power mode M3, lower in the normal mode M1 and further lower in the save mode M2. For example, the automatic downshift speed Nd is set to 3000 [rpm] for the power mode M3 (M=M3), 2000 [rpm] for the normal mode M1 (M=M1) and 1000 [rpm] for the save mode M2 (M=M2).

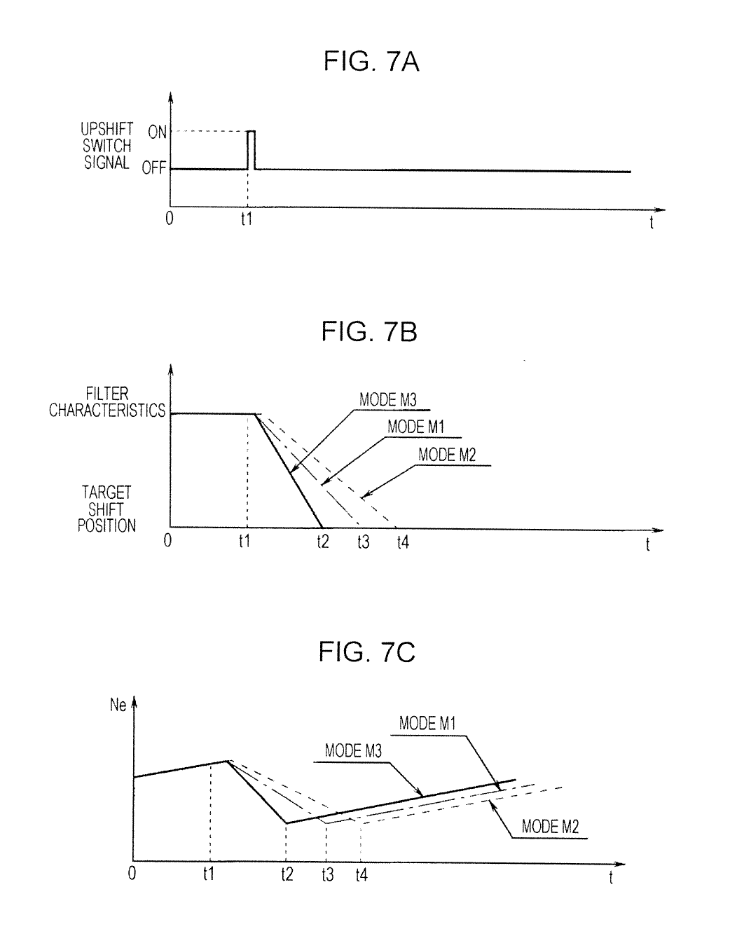

FIG. 7B specifically shows the filter characteristics set in the T/M_ECU 20 which provide different shift characteristics for the driving force modes of the (M1, M2 and M3).

As shown by the filter characteristics in FIG. 7B, a temporal change amount of the transmission gear ratio for a period of time during which the current transmission gear ratio shifts to a target transmission gear ratio is constant between the start and end of the shift in every mode, and varies depending on the driving force modes of the (M1, M2 and M3). In the present embodiment, the temporal change amount of the transmission gear ratio is set highest for the filter characteristic selected in the power mode M3, and set smallest for the filter characteristic selected in the save mode M2. The period of time between the start and end of the shift becomes shortest for the filter characteristic selected in the power mode M3 and longest for the filter characteristic selected in the save mode M2.

Thus, as shown in FIG. 7C, the time for the gear shift in the power mode M3 where a particular emphasis placed on sport driving or maneuverability is be shortened, whereby a more sporty feeling is provided compared to the other two modes M1 and M2. In the save mode M2 a particular emphasis is placed on driving comfort and economy, on the other hand, the time for the gear shift is extended and thus a change in the engine speed caused by the gear shift is suppressed, whereby an inertia change caused by a large pulley is suppressed and a shift shock is reduced, resulting in enhanced comfort.

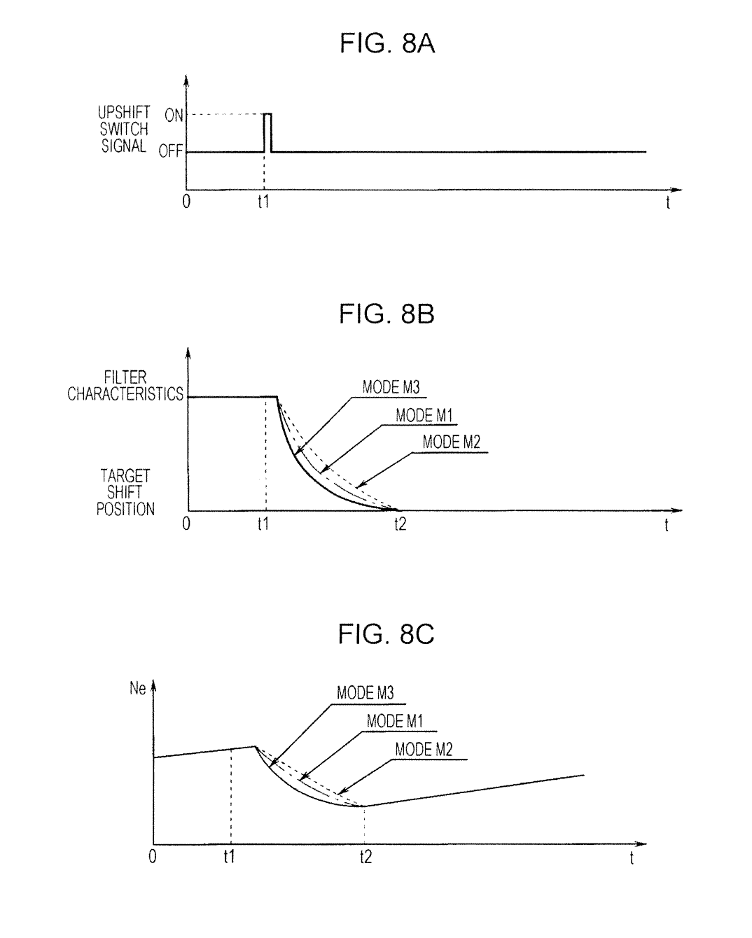

Other filter characteristics such as shown in FIG. 8B may be employed as the shift filter characteristic for controlling the transmission gear ratio changing from the current transmission gear ratio to a target transmission gear ratio. According to the filter characteristics shown in FIG. 8B, although the time for the gear shift between the start and end of the gear shift is substantially same among the modes (M1, M2 and M3), the temporal change amount of the transmission gear ratio is different among the driving force modes of the (M1, M2 and M3) particularly at an early stage of the gear shift. In the characteristics shown in FIG. 8B, the temporal change amount of the transmission gear ratio of the filter characteristic selected in the power mode M3 is set largest, while the temporal change amount of the transmission gear ratio of the filter characteristic selected in the save mode M2 is set smallest. Thus, as shown in FIG. 8C, the gear shift can be increased at the early stage, which is a distinctive aspect of the continuously variable transmission 3, in the power mode M3 where a particular emphasis is placed on sport driving or maneuverability, whereby a more sporty feeling is provided in the power mode M3 compared to the other two modes M1 and M2. In the save mode M2 where a particular emphasis is placed on driving comfort and economy, on the other hand, a change in the engine speed caused by the gear shift is suppressed, whereby an inertia change caused by a large pulley is suppressed and a shift shock is reduced, resulting in enhanced comfort.

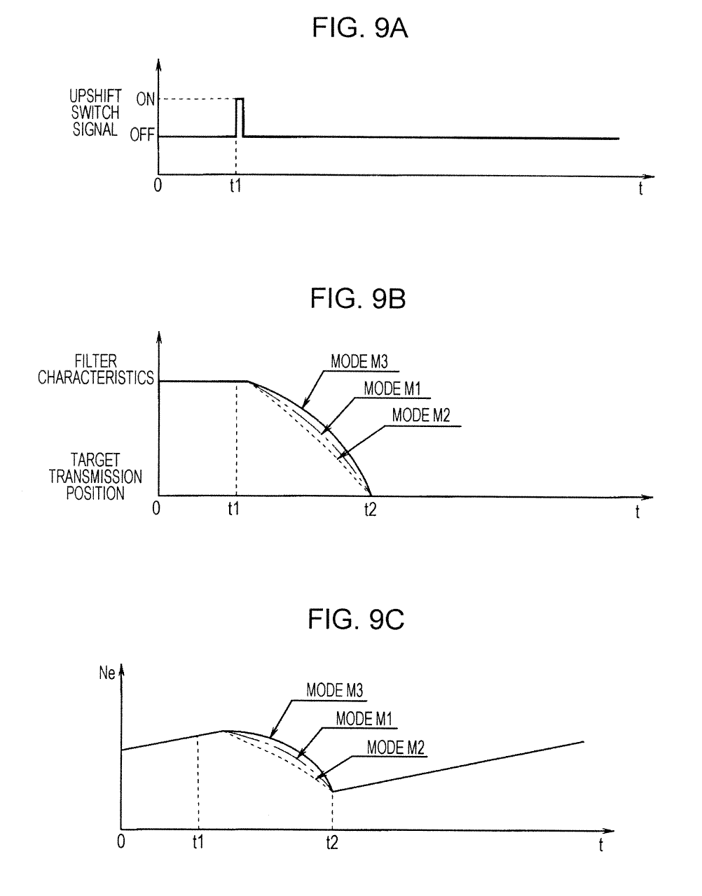

Still further, other filter characteristics shown in FIG. 9B may also be employed in addition to those shown in FIGS. 7B and 8B as the transmission filter characteristic for controlling the transmission gear ratio changing from the current transmission gear ratio to a target transmission gear ratio. According to the filter characteristics shown in FIG. 9B, although the time for the gear shift between the start and end of the gear shift is substantially same among the modes (M1, M2 and M3), the temporal change amount of the transmission gear ratio is different among the driving force modes of the (M1, M2 and M3) particularly before the end of the gear shift. In the characteristics shown in FIG. 9B, the temporal change amount of the transmission gear ratio of the filter characteristic selected in the power mode M3 is set largest, and the temporal change amount of the transmission gear ratio of the filter characteristic selected in the save mode M2 is set smallest. Thus, as shown in FIG. 9C, the end of the gear shift is made noticeable in the power mode M3 where a particular emphasis is placed on sport driving or maneuverability, whereby a more sporty feeling is provided in the power mode M3 compared to the other two modes M1 and M2. In the save mode M2 where a particular emphasis is placed on comfort and economy, on the other hand, a change in the engine speed caused by the gear shift is suppressed, whereby an inertia change caused by a large pulley is suppressed and a shift shock is reduced, resulting in enhanced comfort.

The respective filter characteristics shown in FIGS. 7A to 9C indicate examples for a case where an upshift operation is performed by the driver, and an upshift switching signal is input from the manual switch 40. Similar filter characteristics are applied for a case where a downshift operation is performed by the driver and a downshift switching signal is input.

As described above, the T/M_ECU 20 has functions as a shift characteristic storage unit, a shift characteristic selection unit and a control unit.

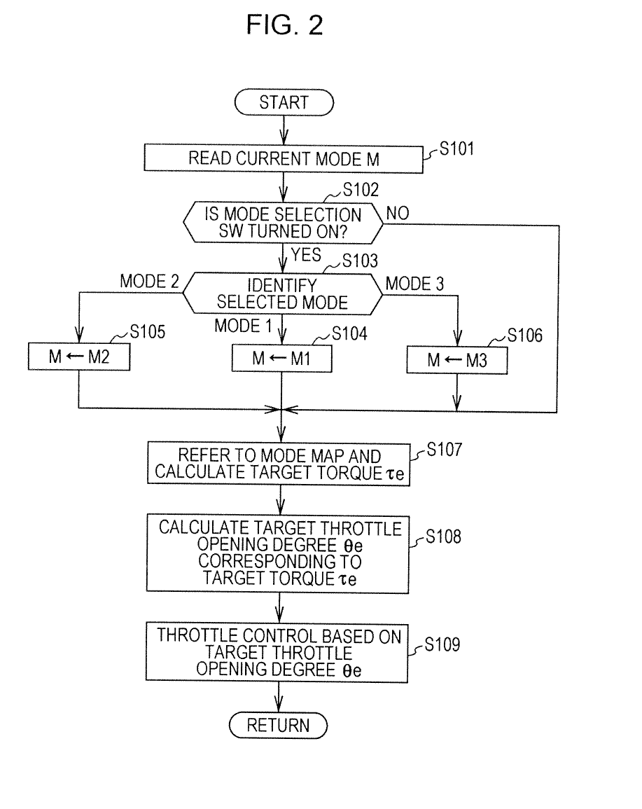

Next, engine throttle control performed by the E/G_ECU 21 will be explained based on a flowchart of a throttle control routine shown in FIG. 2. The routine is executed at every preset time interval. When the routine starts, the E/G_ECU 21 firstly reads a currently set mode M in a step (hereinafter referred to as “S”) 101, and then proceeds to S102.

When the E/G_ECU 21 proceeds to S102 from S101, the E/G_ECU 21 examines whether or not the mode selection switch 35 is turned on. When it is determined that the mode selection switch 35 is not turned on, the E/G_ECU 21 proceeds to S107.

When it is determined in S102 that the mode selection switch 35 is turned on, the E/G_ECU 21 proceeds to S103 where it makes a determination as to which mode the driver has selected.

When it is determined in S103 that the driver has selected the normal mode M1, the E/G_ECU 21 proceeds to S104. where it sets the mode M to the normal mode M1 (M←M1) and proceeds to S107.

When it is determined in S103 that the driver has selected the save mode M2, the E/G_ECU 21 proceeds to S105 where it sets the mode M to the save mode M2 (M←M2) and proceeds to S107.

When it is determined in S103 that the driver has selected the power mode M3, the E/G_ECU 21 moves on to S106 where it sets the mode M to the power mode M3 (M←M3) and proceeds to S107.

When the E/G_ECU 21 proceeds to S107 from S102, S104, S105 or S106, the E/G_ECU 21 reads a mode map Mpe corresponding to the currently selected mode M and determines a target torque re by referring to the mode map Mpe with interpolation calculation on the basis of the current engine speed Ne and the accelerator opening degree θacc.

Then, when the E/G_ECU 21 proceeds to S108 from S107, the E/G_ECU 21 determines a target throttle opening degree θe corresponding to the target torque τe. Then in following S109, the E/G_ECU 21 performs feedback control for the throttle actuator 16a in such a manner that the throttle opening degree θth matches the target throttle opening degree θe. Then, the routine is exited.

As a result, when the driver depresses the accelerator pedal, the throttle valve 16 is opened or closed bases on the parameters including the accelerator opening degree θacc and the engine speed Ne according to the mode M selected by the driver, thereby allowing the engine 1 to be operated so as to provide an output characteristic that varies according to the mode M.

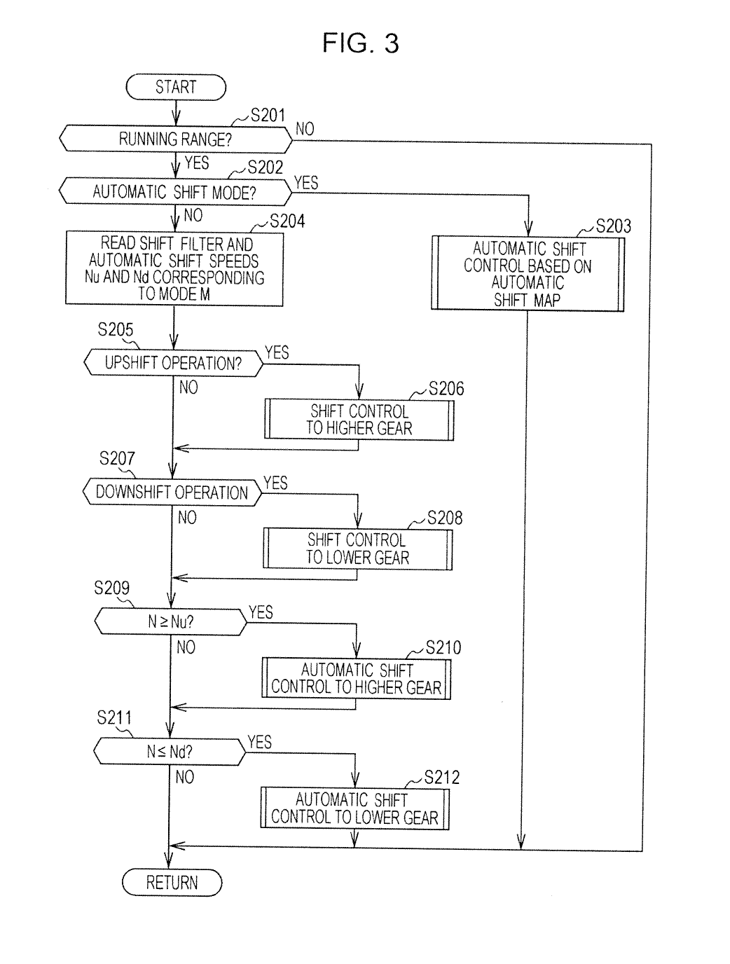

Next, shift control of the continuously variable transmission 3 that is executed by the T/M_ECU 20 will be explained according to a flowchart of a shift control routine shown in FIG. 3. The routine is executed at every preset time interval. When the routine starts, the T/M_ECU 20 firstly examines S201 in whether or not the currently selected range on the selector 36 is a running range (that is, the drive range or the manual range).

When it is determined in S201 that the current range is other than the running range, the T/M_ECU 20 exits the routine without any change.

When it is determined in S201 that the current range is the running range, the T/M_ECU 20 proceeds to S202 where a determination is made as to whether or not the current range is the drive range, that is, whether the automatic shift mode is selected as the control mode of the continuously variable transmission 3.

When it is determined in S202 that the current range is the drive range and thus the automatic shift mode is selected as the control mode, the T/M_ECU 20 proceeds to S203 where automatic shift control is performed on the basis of an automatic shift map. Then the T/M_ECU 20 exits the routine.

Specifically, in S203 the T/M_ECU 20 selects an automatic shift map Mpt corresponding to the mode M currently selected by the mode selection switch 35 from among the automatic shift maps Mpt1 to Mpt3. Then, by referring to the selected automatic shift map Mpt, the T/M_ECU 20 sets a target primary speed Npt based on the vehicle speed V and the accelerator opening degree θacc in order to perform automatic shift control through the control of the hydraulic pressures supplied to the hydraulic pressure chamber 5f and the hydraulic pressure chamber 5g from the hydraulic pressure control circuit 8 such that the primary speed Np matches the target primary speed Npt.

Meanwhile, when it is determined in S202 that the current range is the manual range and that the manual shift mode is selected as the control mode, the T/M_ECU 20 proceeds to S204 where T/M_ECU 20 reads the manual shift map Mptm as well as a shift filter of a shift characteristic corresponding to the mode M currently selected by the mode selection switch 35, the automatic upshift speed Nu and the of automatic downshift speed Nd.

When the T/M_ECU proceeds to S205 from S204, the T/M_ECU 20 examines whether or not an upshift operation is performed by the driver on the basis of a signal from the manual switch 40. When it is determined that an upshift operation is performed, the T/M_ECU 20 proceeds to S206. When it is determined that no upshift operation is performed, the T/M_ECU 20 proceeds to S207.

When the T/M_ECU proceeds to S206 from S205, the T/M_ECU 20 examines whether or not the manual shift map Mptm includes a transmission gear stage that is higher than the current transmission gear stage. If a higher transmission gear stage is included, the T/M_ECU 20 controls the hydraulic pressures supplied to the hydraulic pressure chambers 5f and 5g from the hydraulic pressure control circuit 8 according to the characteristic of the selected shift filter so as to shift up the transmission gear ratio of the continuously variable transmission 3 to a fixed transmission gear ratio of a transmission gear stage that is higher by one stage than the current transmission gear stage. Then, the T/M_ECU 20 proceeds to S207.

When T/M_ECU 20 proceeds to S207 from S205 or S206, the T/M_ECU 20 examines whether or not a downshift operation is performed by the driver on the basis of a signal from the manual switch 40.

When it is determined in S207 that a downshift operation is performed, the T/M_ECU 20 proceeds to S208. When it is determined that no downshift operation is performed, the T/M_ECU 20 proceeds to S209.

When the T/M_ECU 20 proceeds to S208 from S207, the T/M_ECU 20 examines whether or not the manual shift map Mptm includes a transmission gear stage that is lower than the current transmission gear stage. If a lower transmission gear is included, the T/M_ECU 20 controls the hydraulic pressures supplied to the hydraulic pressure chambers 5f and 5g from the hydraulic pressure control circuit 8 according to the characteristic of the selected shift filter so as to shift down the transmission gear ratio of the continuously variable transmission 3 to a fixed transmission gear ratio of a transmission gear stage that is lower by one stage than the current transmission gear stage. Then, the T/M_ECU 20 proceeds to S209.

When the T/M_ECU 20 proceeds to S209 from S207 or S208, the T/M_ECU 20 examines whether or not the primary speed No is higher than or equal to the currently selected automatic upshift speed Nu. When it is determined that the primary speed Np is higher than or equal to the automatic upshift Nu, the T/M_ECU 20 proceeds to S210. When it is determined that the primary speed Np is lower than the automatic upshift speed Nu, the ECU 20 proceeds to S211.

When the T/M_ECU 20 proceeds to S210 from S209, the T/M_ECU 20 examines whether or not the manual shift map Mptm includes a transmission gear stage that is higher than the current transmission gear stage. If a higher transmission gear stage is included, the T/M_ECU 20 controls the hydraulic pressures supplied to the hydraulic pressure chambers 5f and 5g from the hydraulic pressure control circuit 8 so as to shift up the transmission gear ratio of the continuously variable transmission 3 to a fixed transmission gear ratio of a transmission gear stage that is higher by one stage than the current transmission gear stage. Then, the T/M_ECU 20 proceeds to S211.

When the T/M_ECU 20 proceeds to S211 from S209 or S210, the T/M_ECU 20 examines whether or not the primary speed Np is lower than or equal to the currently selected automatic downshift speed Nd. Upon identifying that the number of primary rotations Np is lower than or equal to the number of automatic downshift rotations Nd, the T/M_ECU 20 moves on to S212. When it is determined that the primary speed Np is higher than the automatic upshift speed Nd, the T/M_ECU 20 exits the routine without any change.

When the T/M_ECU 20 proceeds to S212 from S211, the T/M_ECU 20 examines whether or not the manual shift map Mptm includes a transmission gear stage that is lower than the current transmission gear stage. If a lower transmission gear is included, the T/M_ECU 20 controls the hydraulic pressures supplied to the hydraulic pressure chambers 5f and 5g from the hydraulic pressure control circuit 8 so as to shift down the transmission gear ratio of the continuously variable transmission 3 to a fixed transmission gear ratio of a transmission gear that is lower by one stage than the current transmission gear stage. Then, the T/M_ECU 20 exits the routine.

According to the embodiment of the present invention, as described above, the plurality of driving force modes (M1, M2 and M3) is provided in which an engine generates driving force in response to an accelerator operation. Further, the automatic shift mode in which the transmission gear ratio is automatically controlled according to a preset shift characteristic and the manual shift mode in which one of the preset transmission gears can be manually selected are provided as the control mode of the continuously variable transmission 3. The filter characteristic that is set as the shift characteristic for shifting from the current transmission gear ratio to a target transmission gear ratio in the manual shift mode provides a different shift characteristic to each of the driving force modes (M1, M2 and M3). When the manual shift map Mptm is selected, a filter characteristic of a shift characteristic is selected that corresponds to the currently selected mode (M1, M2 or M3), and shifting is performed according to the thus selected shift characteristic. Thus, a more sporty feeling is provided in the power mode M3 where a particular emphasis is placed on sport driving or maneuverability compared to the other two modes M1 and M2. In the save mode M2 where a particular emphasis is placed on comfort and economy, on the other hand, a change in the engine speed caused by the gear shift can suppressed, whereby an inertia change caused by a large pulley is suppressed and a shift shock is reduced, resulting in enhanced comfort. As a result the manual shift mode is variably controlled according to the driving force characteristic selected by the driver, whereby a distinct difference can be made among the driving force modes selected by the driver and thus driver's convenience can be enhanced.

The embodiment of the present invention has been explained by way of an example of an apparatus operable in three driving force modes. However, the present invention is not limited to this. The present invention can be applied to apparatuses operable in two driving force modes or four or more driving force modes. Further, the embodiment of the present invention has been explained by way of an example in which the automatic transmission is a continuously variable transmission. However, the present invention is not limited to this. a gear shift in an automatic transmission mode of a multistage transmission and a gear shift in a manual shift mode are within the scope of the application.

What is claimed is:

1. A vehicle shift control apparatus that is operable in a vehicle having a plurality of driving force modes in which an engine generates driving force in response to an accelerator operation and a shift control unit for controlling a transmission gear stage or a transmission ratio of an automatic transmission connected to the engine according to a preset shift characteristic, the apparatus comprising:
a shift characteristic storage unit in which a shift characteristic for shifting from a current transmission gear stage to a target transmission gear stage by means of the transmission control unit is stored for each of modes;
a shift characteristic selection unit for selecting a shift characteristic which corresponds to a currently selected mode; and
a control unit for performing a gear shift according to the selected shift characteristic so as to change a transmission gear stage.

2. The vehicle shift control apparatus according to claim 1, wherein in the shift characteristic a temporal change amount of the transmission gear stage from the current transmission gear stage or transmission ratio to the target transmission gear stage or transmission ratio is different among the modes.

3. The vehicle shift control apparatus according to claim 1, wherein:
the plurality of modes includes at least a first mode that places a particular emphasis on comfort-oriented, economy-oriented driving and a second mode that places more emphasis on sport-oriented, maneuverability-oriented driving more than in the first mode; and
a temporal change amount of the transmission gear stage or transmission ratio in at least one of initial and completion stages of the gear shift in the second mode is set greater than the temporal amount change of the transmission gear stage or transmission ratio in the first mode.

4. The vehicle shift control apparatus according to claim 2, wherein:
the plurality of modes includes at least a first mode that places a particular emphasis on comfort-oriented, economy-oriented driving and a second mode that places more emphasis on sport-oriented, maneuverability-oriented driving more than in the first mode; and
a temporal change amount of the transmission gear stage or transmission ratio in at least one of initial and completion stages of the gear shift in the second mode is set greater than the temporal amount change of the transmission gear stage or transmission ratio in the first mode.

5. The vehicle shift control apparatus according to claim 1, wherein:
the plurality of modes includes at least a first mode that places a particular emphasis on comfort-oriented, economy-oriented driving and a second mode that places more emphasis on sport-oriented, maneuverability-oriented driving more than in the first mode; and
a period of time for the gear shift from a start of the gear shift to an end of the gear shift in the second mode is set shorter than a period of time for the gear shift in the first mode.

6. The vehicle shift control apparatus according to claim 2, wherein:
the plurality of modes includes at least a first mode that places a particular emphasis on comfort-oriented, economy-oriented driving and a second mode that places more emphasis on sport-oriented, maneuverability-oriented driving more than in the first mode; and
a period of time for the gear shift from a start of the gear shift to an end of the gear shift in the second mode is set shorter than a period of time for the gear shift in the first mode.

7. The vehicle shift control apparatus according to claim 3, wherein:
the plurality of modes includes at least a first mode that places a particular emphasis on comfort-oriented, economy-oriented driving and a second mode that places more emphasis on sport-oriented, maneuverability-oriented driving more than in the first mode; and
a period of time for the gear shift from a start of the gear shift to an end of the gear shift in the second mode is set shorter than a period of time for the gear shift in the first mode.

8. The vehicle shift control apparatus according to claim 4, wherein:
the plurality of modes includes at least a first mode that places a particular emphasis on comfort-oriented, economy-oriented driving and a second mode that places more emphasis on sport-oriented, maneuverability-oriented driving more than in the first mode; and
a period of time for the gear shift from a start of the gear shift to an end of the gear shift in the second mode is set shorter than a period of time for the gear shift in the first mode.
